(19) United States
(12) Patent Application Publication
(10) Pub. No.: US 2008/0235176 A1
(43) Pub. Date: Sep. 25, 2008

(54) DATA COMPARATOR

(75) Inventor: Darko Kirovski, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/689,573

(22) Filed: Mar. 22, 2007

(51) Int. Cl. G06F 17/30

(52) U.S. Cl. 707/1; 707/E17.014

(57) ABSTRACT

A system that identifies commonalities and/or differences in data is disclosed. Specifically, the innovation employs hashing algorithms to identify similarities and/or differences in data from one entity by comparing a hash of the data to a hash of data of another entity. The hashing functionality maintains privacy and/or confidentiality of the information thereby reducing the possibility of accidental or unwanted disclosure.

### BACKGROUND

Due to advances in computing technology, businesses today are able to operate more efficiently when compared to substantially similar businesses only a few years ago. For example, high speed data networks enable employees of a company to instantaneously transfer data files to employees or other to other companies, manipulate data files, share data relevant to a project to reduce duplications in work product, etc. However, unless adequately protected, data transfer often leaves data vulnerable. Thus, maintaining privacy of sensitive data is of great concern.

Unsecured transmission of data can make data vulnerable to unintentional or even malicious access. This can be problematic especially when sensitive data is transmitted, for example, private financial or personal information (e.g., social security numbers, driver's license data). In most cases, files and other data are locally stored within the resident computer or upon a secure intranet. Thus, security of data can be manageable since the data is most often limited to locally accessible and restricted data stores. This is not the case when the data is transmitted from one computer to another.

Cryptography refers to a conversion of data into a secret code for transmission over a public network. In order to secure data transmission, the original text, or ‘plaintext,’ can be converted into a coded equivalent called ‘ciphertext’ via a proprietary encryption algorithm. Subsequently, to restore the data to a readable form, the ciphertext can be decoded or decrypted at the receiving end to restore the data into plaintext.

Generally, proprietary encryption algorithms use a key, which is typically a binary number from 40 to 128 bits in length. The ‘cipher strength’ is a function of the number of bits. For example, the greater the number of bits in the key, the more possible key combinations and, thus, the longer it would potentially take to break the code. The data is encrypted, or ‘locked,’ by mathematically combining the bits in the key with the data bits. At the receiving end, the key is used to ‘unlock,’ or decrypt, the code to restore the original data.

Conventionally, there are two cryptographic methods, ‘symmetric’ and ‘public-key’ cryptography. The traditional symmetric method uses a secret key, such as the DES standard. In accordance with symmetric cryptography, both sender and receiver use the same key to encrypt and decrypt. Symmetric key algorithms are generally faster than other cryptographic methods, but these methods sometimes involve transmitting a secret key to the recipient which can be difficult and sometimes not secure.

The second method is public-key cryptography, such as RSA, which uses both a private and a public key. Each recipient has a private key that is kept secret and a public key that is published for everyone. The sender employs the recipient's public key and uses it to encrypt the message. Upon receipt, the private key can be used to decrypt the message. In other words, because owners do not have to transmit their private keys to anyone in order to decrypt messages, the private keys are not in transit and are not vulnerable.

Oftentimes it is necessary to track personal information for business reasons. For example, when one professional sells a business to another, it is necessary to track client or patient defections as they are valuated in the deal. Identification of defections can be accomplished by comparing one client/patient list to another. While cryptography can be used to protect the data during transmission, once the information is decrypted, it is readable thereby exposing the private information (e.g., social security information). Furthermore, conventional systems require manual comparison of lists which can be expensive and prone to human error.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that can securely determine commonalities and/or differences in data items maintained in at least two disparate lists. Hashing techniques can be employed to effectuate the comparison while maintaining privacy and confidentiality of the information. Optionally, the transmitted hashed list can be digitally signed or encrypted to further protect integrity of the data. In this embodiment, the receiving entity can decrypt the information and thereafter commence comparison of the data.

In another aspect, of the subject innovation system can employ logic to establish permutations of data contained in any of the subject lists. These permutations can enhance the accuracy of the comparison by establishing variations of the data to overcome typographical errors as well as formatting inconsistencies. For example, a date format (e.g., Sep. 15, 2006) can be converted into multiple permutations (e.g., Sept. 15, 2006, 09/15/06, 09/15/2006, 15.09.06) which enhance the possibility of matching and/or locating formatting inconsistencies.

In yet another aspect thereof, machine learning and reasoning mechanisms are provided that employ a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates comparing data between at least two entities in accordance with an aspect of the innovation.

FIG. 2 illustrates an exemplary flow chart of procedures that facilitate concatenation, hashing, aggregation and transmission of a source list in accordance with an aspect of the innovation.

FIG. 3 illustrates an exemplary flow chart of procedures that facilitate generation of a local hashed list and comparison with the source list in accordance with an aspect of the innovation.

FIG. 4 illustrates a block diagram of an example list generation component that establishes a hashed list of items from a source in accordance with an aspect of the innovation.

FIG. 5 illustrates a block diagram of an example list comparator component that facilitates comparing the hashed source list to a hashed list of local items.

FIG. 6 illustrates a block diagram of an alternative list generation component that facilitates signing or encrypting the hashed source list in accordance with an aspect of the innovation.

FIG. 7 illustrates a block diagram of an alternative list comparator component that facilitates decryption of an encrypted source list in accordance with an aspect of the innovation.

FIG. 8 illustrates a block diagram of two entities that facilitates automatic comparison of data while maintaining privacy in accordance with an aspect of the innovation.

FIG. 9 illustrates a block diagram of a computer operable to execute the disclosed architecture.

FIG. 10 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

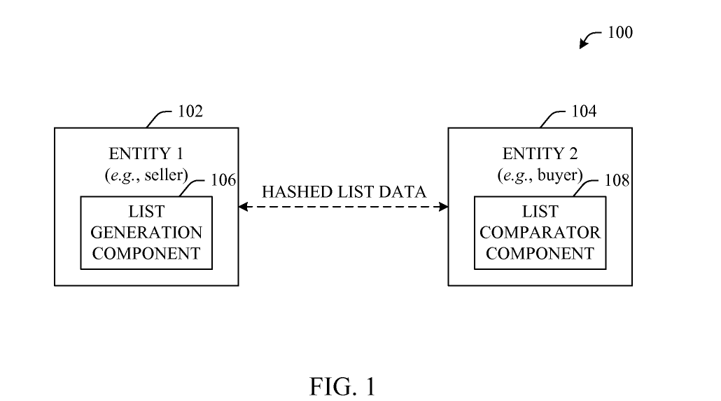

Referring initially to the drawings, FIG. 1 illustrates a system 100 that facilitates securely comparing data elements in at least two lists, for example, to identify any overlapping and/or differing entries. In one specific example, when one health-care professional who owns a practice with certain patients sells this practice to another, typically the buyer is left without any tools to verify whether any of seller's current patients will defect to the seller's new practice. Common practice in the industry is that the seller pays a fixed fee to the buyer for each defected patient.

Because of this common contractual arrangement, it is important to the buyer to identify any such defections. However, the seller is not inclined to reveal the privacy of his/her patients in his/her new office for privacy reasons as well as protection of business interests. The subject innovation can address these types of situations by employing cryptographic and/or hashing mechanisms to address these privacy concerns thereby maintaining confidentiality against accidental and/or malicious disclosure.

As illustrated in FIG. 1, system 100 can include a first entity 102 (e.g., seller) that transmits data (e.g., patient data) to a second entity (e.g., seller) for comparison while maintaining confidentiality and/or masking the content of the data. While many of the examples described herein are directed to comparing patient lists in a health-care environment, it is to be understood that the features, functions and benefits described herein can be employed in most any application where it is desired to identify commonalities and/or differences in lists, for example non-compete applications of an employee with respect to customer lists, etc. Additionally, as two entities are illustrated in FIG. 1, it is to be understood that the innovation can be applied to any number of entities thereby establishing commonalities and/or differences between data maintained within each while maintaining confidentiality of the data.

In order to facilitate transfer of the list, the first entity 102 can include a list generation component 106 that enables aggregation of the list as well as establishing a hash of the list. This hashed list can be transferred to the second entity 104 where a list comparator component 108 can be employed to compare each of the received items with locally maintained items. As will be described below, the list generation component 106 and/or the list comparator component 108 can also apply logic which generates variations or permutations of each item in the respective list(s). Thus, the permutations can be compared to the items in the respective lists to determine overlap and/or differences in the list(s).

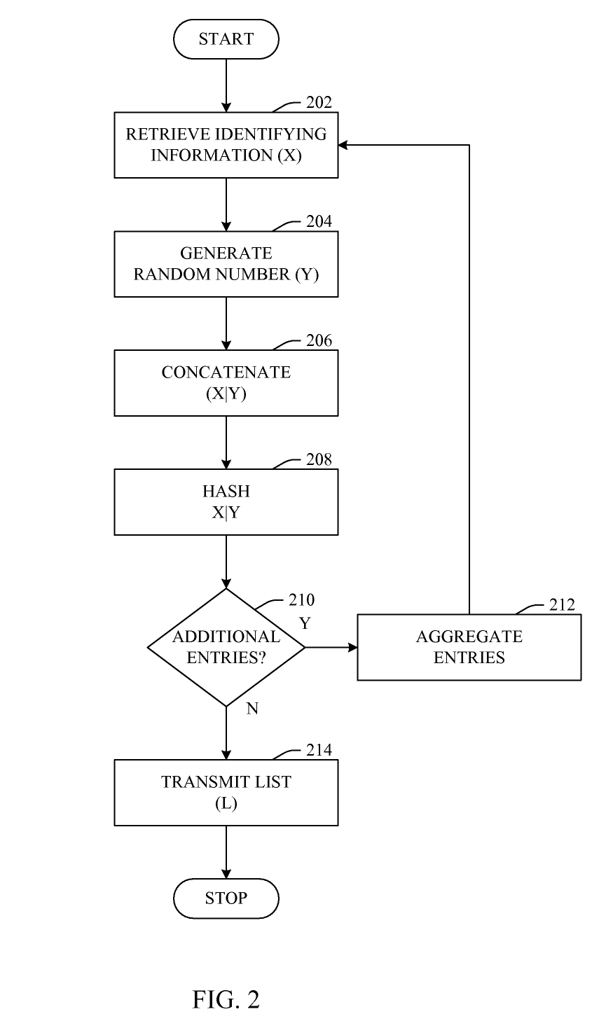

FIG. 2 illustrates a methodology of generating a hashed source list in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, identifying information can be retrieved, gathered or obtained. For example, continuing with the example above, patient's names, social security numbers (SSNs), dates of birth, addresses, phone numbers, etc. can be gathered and aggregated as desired. For instance, a patient's last name can be aggregated with a SSN to form X. At 204, a random number (Y) can be generated at 204. It is to be understood that this random number can be of any desired length.

At 206, the identifying information (X) can be concatenated or linked with the random number (Y) to form a single string (X|Y). While a specific concatenation is described, it is to be understood that information can be grouped or linked in any manner desired in order to sufficiently describe each item (e.g., patient) in a list. Additionally, other concatenations can be established which include information sufficient to identify each item (e.g., patient, customer) in the list.

At 208, a hash of the concatenation is established which protects the content of the information upon transmission and delivery to a receiver. It is to be understood that most any hash algorithm known in the art can be employed to hash the concatenation at 208. For instance, SHA-0, SHA-1, SHA-224, SHA-256, SHA-384 or SHA-512 hashing algorithms can be employed in disparate embodiments.

One key component (or act) of the innovation is the cryptographic hash. In the health-care example noted above, when the buyer wants to inspect the seller's new office for defected patients, the seller can create the following data for each patient. At 202, for each patient, seller's software computes X, a string of characters that encompasses sufficient identifying information about the patient (e.g., name, date of birth, and SSN). Next, at 204, the seller generates Y, a random number of sufficient bit length, for example, 128 bits. At 206, X|Y, the concatenation of X and Y is generated and hashed at 208 using a cryptographic hash function h( ) such as SHA-256.

A determination is made at 210 to ascertain if additional entries are available. If so, the entry is aggregated into a list and the methodology returns to 202 to retrieve identifying information for the next item. Once all items are hashed, at 214, the seller sends L, the list of {H=h(X|Y),Y} for each patient to buyer upon request.

In other aspects, H can also be signed with a private key (e.g., the private key of the seller or software manufacturer). This signature can be supplied to a second entity (e.g., buyer) as well as a confirmation that the “patient hash list” is authentic. The buyer can verify this authenticity using seller's public key. Because of the hashing operation, the buyer cannot tell anything about X based upon H and Y. Thus, confidentiality is maintained.

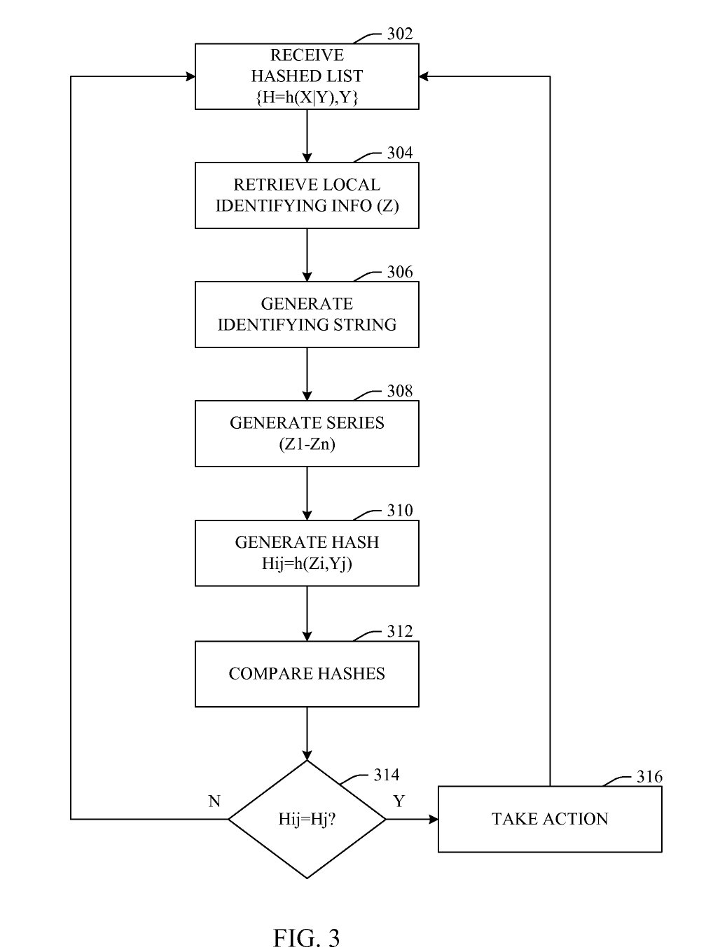

Referring now to FIG. 3, there is illustrated a methodology of comparing information in accordance with the innovation. At 302, the hashed list is received. It will be understood that this list can be received in most any manner including, but not limited to, automatic pulling from a source, automatic receipt via push from a source, manual load via a computer media or the like. These alternative aspects are to be included within the scope of the innovation and claims appended hereto.

At 304, local information can be retrieved. Here, information that identifies elements of the second list can be retrieved. An identifying string (or group of strings) can be established at 306. In other words, identifying information can be concatenated to establish a string(s) that represents the local data element(s).

At 308, a series of strings can be generated that represent permutations of the items maintained locally. Alternatively or additionally, as described above, strings that represent permutations of the items in the first list can be established for comparison to the second list. In either case, it is to be understood that the permutations are generated to establish alternative expressions that represent the same data. For example, phonetics can be employed to generate alternative spellings and or abbreviated expressions that represent the same data. Similarly, information such as dates (e.g., Sep. 15, 2006) can be expressed in abbreviated numeric form (e.g., 9/15/07, 9.15.07, 15.9.07 among others). It will be appreciated that most any information can be expressed in some alternative form.

A hash of the strings can be established at 310 for comparison to the hashed strings from the original list. It will be understood that, because the information is hashed, privacy of the information received from the source can be maintained. The hashes can be compared at 312 and a determination if a match is determined at 314. If there is a match, in one aspect, action can be taken. In other words, the receiving entity can pursue compensation in accordance with the aforementioned health-care example.

Continuing with the health-care example described above, the buyer of a practice can perform the following procedure to determine whether any current patients are on L, the seller's new patient list. As described above, for each patient in her local database, she computes and generates its identifying string Z. As mistakes can happen in data entry, the verifier can generate a series of strings Z1-Zn based upon some algorithm, where n is an integer. By way of example, such an algorithm can be employed in situations of usage of an inverted month-day for date of birth, omission of SSN or date of birth, etc.

Next, for each entry {Hj, Yj} in the seller supplied list, the buyer computes Hij=h(Zi,Yj) and compares it with Hj. If Hij=Hj, then the buyer identifies a match and can take further legal action, for example, pursue compensation for a defected patient. It will be appreciated that the seller may tamper with the software that produces L, for example by omitting certain patients. In that case, if the buyer realizes a patient defection using different means, the seller may face criminal conduct charges in addition to punitive damages against buyer. For at least this reason, it is unlikely that a seller will alter the list prior to sending to the buyer for comparison.

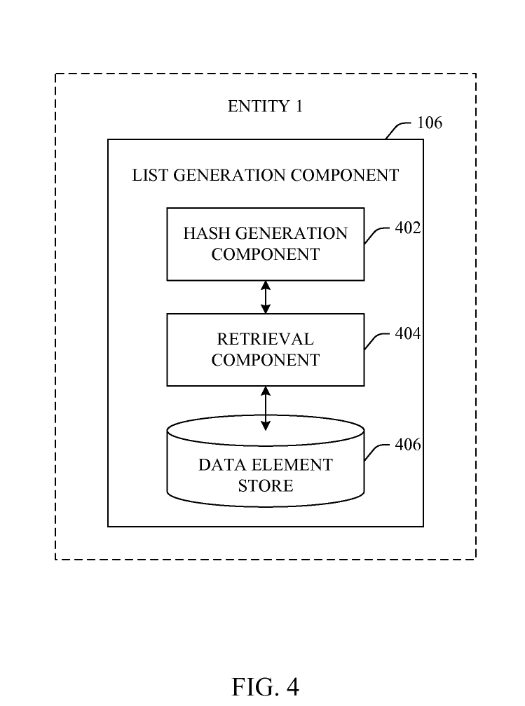

Referring now to FIG. 4, there is illustrated an example list generation component 106 in accordance with the innovation. Generally, the list generation component 106 can include a hash generation component 402, a retrieval component 404 and a data element store 406. In operation, these components facilitate aggregation of a hashed list of elements which can be employed by the list comparator component (104 of FIG. 1) to identify any common as well as differing elements between at least two lists.

Continuing with the example above wherein a seller sells a medical practice to a buyer, the retrieval component 404 can be employed to gather appropriate data elements (e.g., patient information) from a data element store 406. In accordance with this example, the retrieval component 404 can be employed to aggregate a list of either all or any desired subset of data elements maintained within the data element store 406.

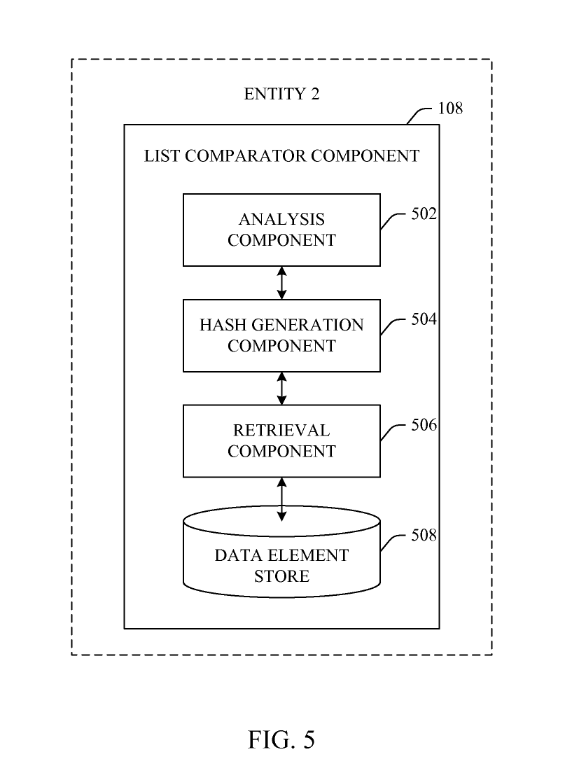

The hash generation component 402 can be employed to hash each of the retrieved data elements. Here, the privacy and/or confidentiality of the data is maintained as the hashing algorithm inherently masks the information making it unreadable with regard to the details of the information. As described above, most any hashing algorithm can be used in accordance with aspects of the innovation. For example, a SHA-1 or a SHA-256 hashing algorithm can be employed in disparate aspects. Once the information is hashed, it can be employed by a list comparator component (104 of FIG. 1) as illustrated in FIG. 5 that follows.

FIG. 5 illustrates an example list comparator component 108 that is capable of comparing data hashed data received from a source (e.g., Entity1 of FIG. 1). Generally, the list comparator component 108 can include an analysis component 502, a hash generation component 504, a retrieval component 506 and a data element store 508. Essentially, these components enable the list comparator component 108 to identify any commonalities and/or differences between local data elements in view of the list compiled by the list generation component (102 of FIG. 1).

In operation, the retrieval component 506 can access information about local data elements maintained within the data element store 508. As described with reference to the retrieval component of FIG. 4, here, identifying information can be retrieved, concatenated as desired, and aggregated into a list of elements. It will be understood that the retrieval component 506 can employ a predetermined standard to compile a list which is in a comparable format as the list received from the source. In other words, suppose the source concatenates a patient last name along with their SSN and date of birth. Here, the retrieval component 506 can establish a comparable list with regard to identifying information from a local data element store 508.

The hash generation component 504 can be employed to establish a hash using the same hashing algorithm as that used by the source. Once the local data is hashed, the analysis component 502 can be employed to determine commonalities and/or differences between the lists. This determination is made by comparing the hashed values. As will be described in greater detail below, logic (or other algorithmic techniques) can be employed to establish permutations of the identifying information to ensure that the data being compared is indeed in the same format as the data supplied. Similarly, the source can also employ this logic to supply alternative entries that represent permutations of the data, again to ensure formatting consistency.

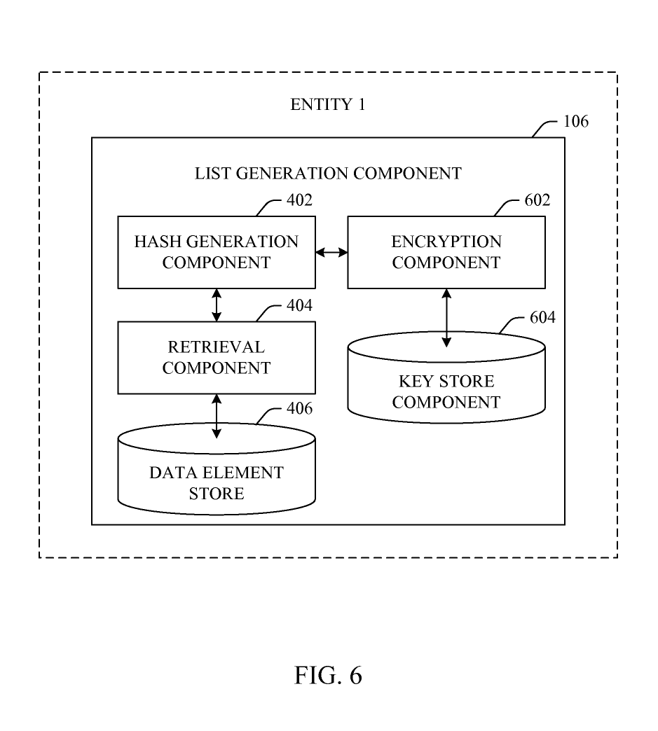

Referring now to FIG. 6, an alternative block diagram of list generation component 102 is shown. More specifically, the list generation component 102 illustrated in FIG. 6 can include an encryption component 602 and a key store component 604 that facilitate encryption of the hashed list prior to transfer or delivery to a comparator entity. In operation, the key store component 604 can be employed to store public keys that correspond to each of a variety of recipients. In this way, the list generation component 102, or specifically the encryption component 602, can employ the public key of a particular recipient to encrypt the list data. Thus, only the recipient that maintains the private key of the public/private key pair will be able to decrypt the information.

In another aspect, the encryption component 602 can employ its own private key to encrypt the information. In this scenario, the target recipient will use the public key of the public/private key pair to decrypt the information thereby enabling the comparison operations described above. It is to be understood that most any suitable encryption algorithm can be used in accordance with aspects of the innovation without departing from the spirit and/or scope of the innovation and claims appended hereto.

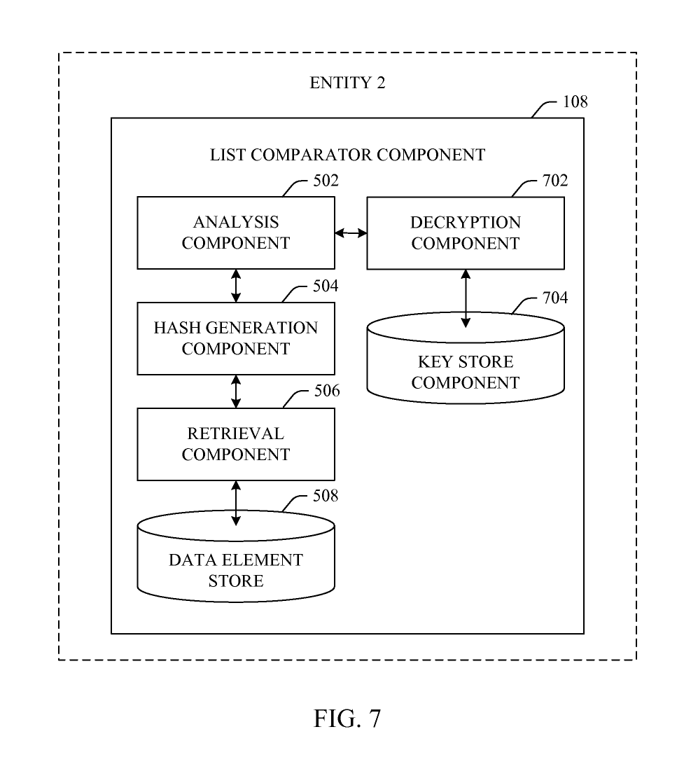

Turning now to FIG. 7, an alternative block diagram of list generation component 104 is shown as having a decryption component 702 and a key store component 704 included therein. Generally, the decryption component 702 can be used to decrypt information that has been encrypted by the encryption component (602 of FIG. 6). As described above, when the information is encrypted using the public key of the receiving entity (e.g., Entity2), decryption can be effectuated by employing the private key that corresponds with the public key.

Similarly, when the information is encrypted using the private key of the source (e.g., Entity1), decryption can occur by employing the public key that corresponds to the source entity. Thus, a key store component 704 can be employed to store public keys that correspond to source entities. Here, the decryption component 702 can look up the appropriate key in the key store 704 thereby facilitating decryption of the data. In yet other aspects, the source can transmit the appropriate key to the receiving entity using a digital envelop or other secure key transfer means. These alternative aspects are to be included within the scope of the disclosure and claims appended hereto.

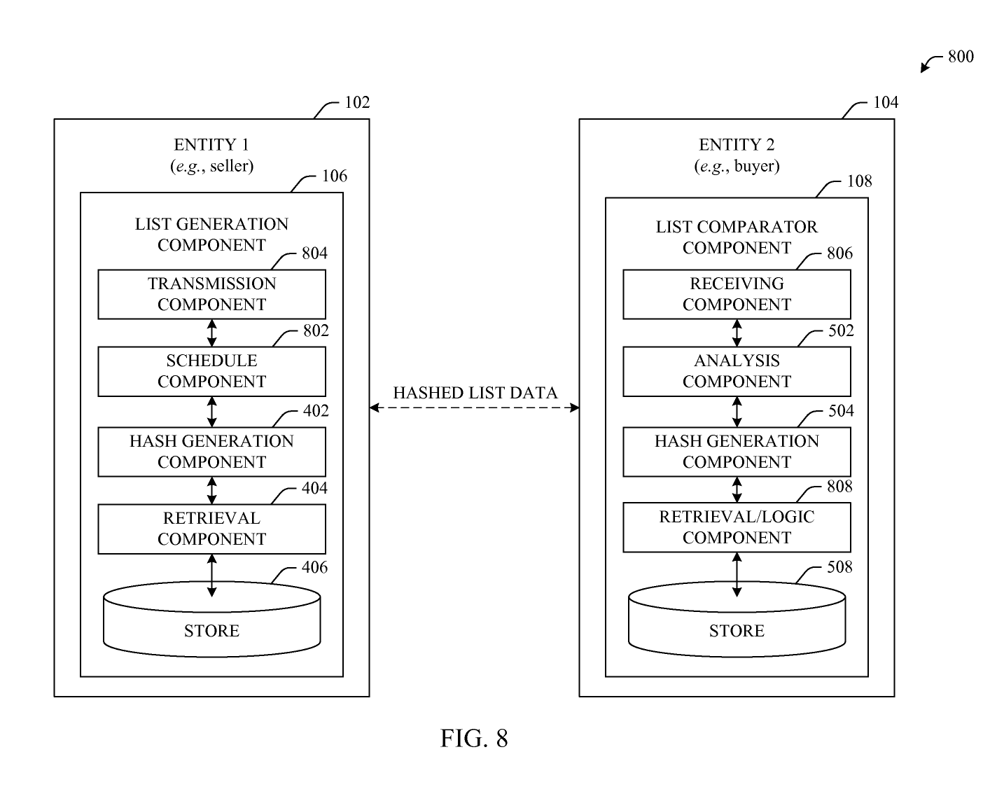

FIG. 8 illustrates a system 800 that facilitates automatic transfer and comparison of information between at least two entities. As shown, a first entity 102 can include a schedule component 802 that facilitates scheduling transmission of information to a receiving entity 104. It is to be understood that the schedule component 802 can trigger transmission based upon a predefined schedule or in an ad hoc manner as a predefined amount of data changes with regard to the first entity's data.

Once the schedule component 802 determines that data should be transmitted, the transmission component 804 can effectuate the transfer of the hashed data. It is to be understood that most any wired or wireless protocol can be used to transfer the data. Similarly, the data can be configured (e.g., ordered) and/or batched in any appropriate manner as desired so as to facilitate efficient comparison of the data. Although not shown in FIG. 8, it is further to be understood that the hashed data can be signed by the source entity using one of a public/private key pair shared with the target entity. Similarly, the data can be decrypted using the other of the public/private key pair at the target destination.

The receiving entity can include a receiving component 806 that accepts or otherwise obtains data from the source entity. For example, the receiving component 806 can accept data pushed from the source entity. Alternatively, the receiving component 806 can pull data from the source entity as desired. Once the data is received, it can be compared to local data in order to identify any commonalities and/or differences in the data.

A retrieval/logic component 808 can be employed to access the local information from the store 508. Here, the retrieval/logic component 808 can access the information as well as establish permutation based upon suitable algorithmic mechanisms and/or logic. For example, for each entry, the retrieval/logic component 808 can generate alternative expressions that format the date of birth in a different manner (e.g., Sep. 15, 2006, 09/15/06, 09/15/2006, 15.09.06). Similarly, variations of names can be established, for example, abbreviated and/or modified to formal given names. By way of example, Jim can be modified to James, James J. can be modified to James Joseph, etc.

These permutations are necessary to ensure that the data is entered in the same manner as that received from the source entity. Thus, when hashed, the commonalities and/or differences in the lists can be easily distinguished. Essentially, these permutations enable a more comprehensive manner by which to compare data between disparate lists.

Still further, the innovation can employ machine learning and/or reasoning mechanisms to automate one or more features in accordance with the subject innovation. The subject innovation (e.g., in connection with establishing permutations) can employ various MLR-based schemes for carrying out various aspects thereof. For example, a process for determining how to configure, reconfigure, correct, etc. received data can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to trigger access to data, when to determine a match exists, which permutations to establish, etc.

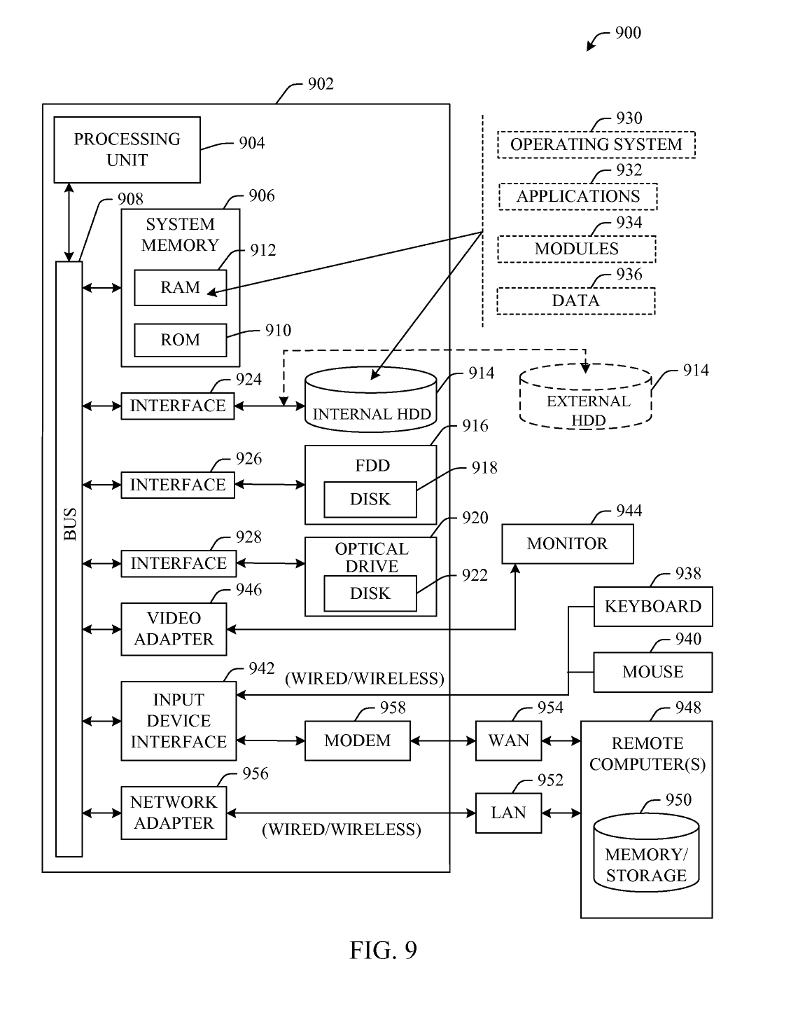

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

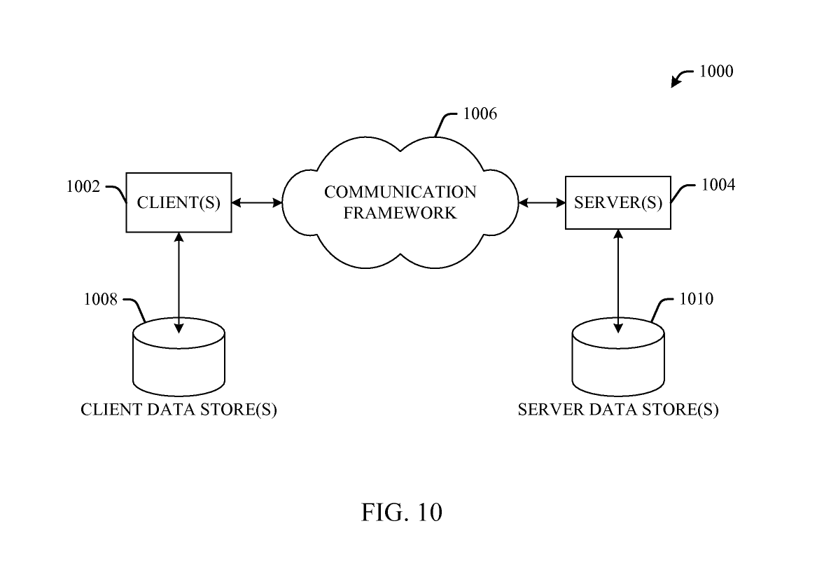

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates comparing lists, comprising:
a list generation component that establishes a hashed set of items of a first list; and
a list comparator component that contrasts each item of the hashed first set with a hash of each item of a second list.

2. The system of claim 1, the list generation component comprises a retrieval component that accesses the set of items that correspond to the first list.

3. The system of claim 2, the list generation component further comprises a hash generation component that generates a hash of each of the set of items in the first list.

4. The system of claim 3, the hash generation component employs at least one of SHA-0, SHA-1, SHA-224, SHA-256, SHA-384 or SHA-512.

5. The system of claim 1, the list comparator component comprises a retrieval component that accesses the set of items that correspond to the second list.

6. The system of claim 5, the list comparator component comprises a hash generation component that generates a hash of each of the set of items in the second list.

7. The system of claim 6, the list comparator component comprises an analysis component that compares the hash of each item of the first list to the hash of each item of the second list.

8. The system of claim 6, further comprising a logic component that establishes a plurality of permutations of each of the items of the second list, wherein the hash generation component generates a hash of each of the plurality of permutations of each of the items of the second list.

9. The system of claim 1, further comprising an encryption component that encrypts each of the hashed first set of items.

10. The system of claim 9, further comprising a key store component, wherein the encryption component locates the public key of a destination within the key store component and employs the public key to encrypt the first set of hashed data items.

11. The system of claim 9, further comprising a decryption that decrypts the encrypted first set of hashed data items.

12. The system of claim 11, further comprising a key store component, wherein the decryption component locates the public key of a source within the key store component and employs the public key to decrypt the first set of hashed data items.

13. The system of claim 1, further comprising a machine learning and reasoning component that employs at least one of a probabilistic and a statistical-based analysis that infers an action that a user desires to be automatically performed.

14. A computer-implemented method of comparing data elements, comprising:
hashing identifying information associated with each item in a first list;
hashing identifying information associated with each item in a second list; and
comparing the hashes of each item of the first list with each item of the second list.

15. The computer-implemented method of claim 14, comprising:
receiving a plurality of identification elements that correspond to each data element of the first list;
generating a random number that corresponds to each of the data elements in the first list; and
concatenating the plurality of identification elements with the random number that corresponds to a like data element, wherein the concatenation defines the identifying information associated with the first list.

16. The computer-implemented method of claim 15, further comprising:
receiving a plurality of identification elements that correspond to each data element of the second list;
generating a random number that corresponds to each of the data elements in the second list;
concatenating the plurality of identification elements with the random number that corresponds to a like data element, wherein the concatenation defines the identifying information associated with the second list.

17. The computer-implemented method of claim 15 further comprising:
generating a plurality of strings associated with each item in the second list as a function of a correction algorithm;
hashing each of the plurality of strings; and
comparing each of the hashed strings with each hashed item of the first list.

18. A computer-executable system comprising:
means for generating a hash of each item in a first list;
means for generating a hash for each item in a second list;
means for comparing the hashed items of the first list with the hashed items of the second list.

19. The computer-executable system of claim 18, further comprising:
means for generating a plurality of strings associated with each item in the second list as a function of a correction algorithm;
means for hashing each of the plurality of strings; and
means for comparing each of the hashed strings with the hashed items of the first list.

20. The computer-executable system of claim 18, further comprising:
means for encrypting each of the hashed items associated with the first list; and
means for decrypting each of the hashed items associated with the first list.
